(19) United States
(12) Patent Application Publication
(10) Pub. No.: US 2009/0316777 A1
(43) Pub. Date: Dec. 24, 2009

(54) Method and Apparatus for Improved Broadcast Bandwidth Efficiency During Transmission of a Static Code Page of an Advertisement

(76) Inventors: Xin Feng, Basking Ridge, NJ (US); Srinivasa Dharmaji, Cupertino, CA (US)

Correspondence Address: GLENN PATENT GROUP, 3475 EDISON WAY, SUITE L, MENLO PARK, CA, 94025, US

(21) Appl. No.: 12/488,354

(22) Filed: Jun. 19, 2009

Related U.S. Application Data
(60) Provisional application No. 61/132,687, filed on Jun. 20, 2008.

(51) Int. Cl. H04N 11/04; G06Q 30/00

(52) U.S. Cl. 375/240.01; 705/14.64; 375/E07.026

(57) ABSTRACT

Advertisements are transferred to mobile handheld displays (MHDs) during slack time, when the spectrum is not busy for download at, and storage on, the MHDs. The stored advertisements are then selectively rendered during available ad spots when the user is viewing content on the MHD. A main code page that comprises all of the pixels that are static within the ad is initially transmitted to the MHD. This transmission is then followed by the transmission of additional packets that include information that only concerns the pixels in the main code page that change from frame to frame, along with information regarding the location of such changes within the code page. There are typically only a small number of changes between frames in an ad, such that only a small amount of information need be transmitted to represent these changes, when compared to the amount of information contained in each frame of the ad. Thus, the bandwidth requirement for transmission of these changes is much less than that of the actual frames.

### CROSS REFERENCE TO RELATED APPLICATIONS

This application claims priority from provisional patent application Ser. No. 61/132,687, Transmission of a Static Code Page of an Advertisement to Improve Broadcast Bandwidth Efficiency, filed Jun. 20, 2008, which application is incorporated herein in its entirety by this reference thereto.

### BACKGROUND OF THE INVENTION

1. Technical Field

The invention relates generally to wireless communication, and more particularly, to a method and apparatus for reducing bandwidth requirements when transferring advertisements to wireless platforms.

2. Description of the Background Art

The wireless spectrum is a very crowded transmission medium. It is also being used more and more for applications that are new and innovative. Hence, there is limited bandwidth availability for transmission of advertisements. This limitation becomes even more acute when multiple, deferred advertisements are simultaneously transmitted via the wireless medium to different targeted groups of users, each user having a mobile handheld display (MHD). Typical practice is to transfer the ads to the MHD during slack time, when the spectrum is not busy, for download to, and storage on, the MHD. The stored ads are then selectively rendered during available ad spots when the user is viewing content on the MHD.

It would be advantageous to provide a method and apparatus for using the broadcast bandwidth more effectively to transfer multiple ads to targeted users of MHDs.

### SUMMARY OF THE INVENTION

A method and apparatus for using available broadcast bandwidth more effectively when transferring multiple advertisements to MHDs is disclosed. Advertisements are transferred to the MHDs during slack time, when the spectrum is not busy for download at, and storage on, the MHDs. The stored advertisements are then selectively rendered during available ad spots when the user is viewing content on the MHD. In a presently preferred embodiment, a main code page that comprises all of the pixels that are static within the ad is initially transmitted to the MHD. This transmission is then followed by the transmission of additional packets that include information that only concerns the pixels in the main code page that change from frame to frame, along with information regarding the location of such changes within the code page. There are typically only a small number of changes between frames in an ad, such that only a small amount of information need be transmitted to represent these changes, when compared to the amount of information contained in each frame of the ad. Thus, the bandwidth requirement for transmission of these changes is much less than that of the actual frames.

### BRIEF DESCRIPTION OF THE DRAWINGS

FIG. 1 is a schematic block diagram of a system for broadcasting advertising to mobile devices according to the invention; and

FIG. 2 is a flow diagram showing the use of a code page for improved bandwidth according to the invention.

### DETAILED DESCRIPTION OF THE INVENTION

Ads that are to be transmitted to an MHD comprise the encoded pixels of each frame of the ad. The inventors have observed that a typical ad lasts for a short duration, and only a very small number of pixels that comprise the ad actually change during rendering of the ad from frame to frame. An embodiment of the invention provides a method and apparatus that initially transmits a main code page that comprises all of the pixels that are static within the ad. This transmission is then followed by the transmission of additional packets that include information that only concerns the pixels in the main code page that change from frame to frame, along with information regarding the location of such changes within the code page. A downloaded software program enables the MHD to reconstruct the ads based upon such information. There are typically only a small number of changes between frames in an ad, such that only a small amount of information need be transmitted to represent these changes, when compared to the amount of information contained in each frame of the ad. Thus, the bandwidth requirement for transmission of these changes is much less than that of the actual frames. By transmitting the code page plus the changes to the code page, the total bandwidth used for any single ad transmission is substantially reduced.

An embodiment provides a facility that compares each frame in the ad with the rest of the frames in the ad. Often a large number of the pixels are the same in a series of frames in any ad. This static information from the frames is converted to a static code frame that comprises a picture. Hence, the code frame uses a very small amount of bandwidth during its transmission. The dynamic information from each frame is taken out of the frame and sent separately to the MHD as additional information, thus significantly reducing the total bandwidth that is required to transmit an ad. The static code page and additional information are used to reconstruct the original ad frames at the MHD. The use of a static code page and additional information for ad transmission is completely different from the use of temporal compression to transmit images by comparing each frame to its previous frame for coding. However, the comparison technique of the frame-by-frame method can also be used to compare the additional information portion of the ad transmission in the present invention. This reduces the amount of transmitted information content in the additional information and, hence, further reduces the amount of bandwidth required to transmit an ad.

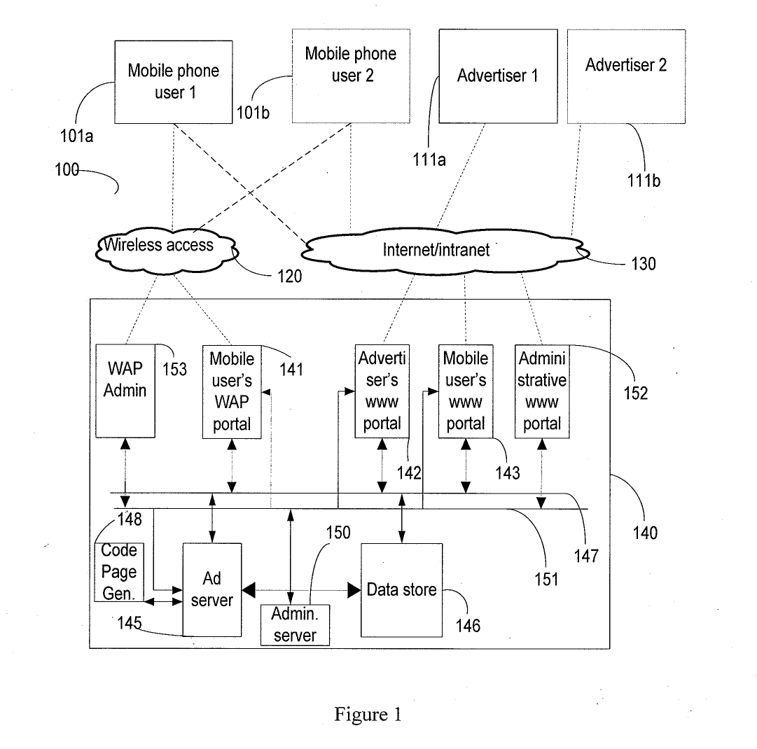

The components of a mobile advertising system 100 according to the invention are shown in FIG. 1. The system 100 comprises an ad server 145 that is connected to a data store 146 in which ads received from advertisers 11a and 11b are stored. In a typical embodiment, advertisements are made available via the Internet/intranet 130 from the advertiser's portal 142, or by alternate means of delivery (not shown) directly, for access by the ad server 145 and the data store 146. The ad server 145 enables a code page generator 148 to generate the code page and the additional information that enhance the code page for any ad to be transmitted. The ad server 145 also enables the transmission of the code page and the additional information in response to commands from the administrative server 150. The administrative server 150 handles the administration of the ad server 145, the data store 146, the code page generator 148, and the portals via the administrative bus 151. The ads are transmitted to the MHDs wirelessly during periods of bandwidth availability. The use of a code page and limited additional information content allows the ad server 145 to reduce the total bandwidth needed for transmission of an ad. This enables more ads to be transmitted to the MHDs, e.g. mobile phones 101, over the wireless medium within the available bandwidth and time, for storage and display at the proper ad spot during user viewing of content on an MHD.

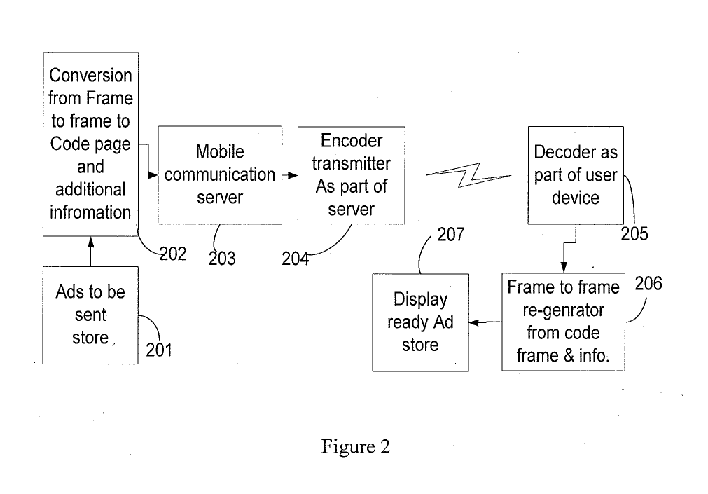

FIG. 2 is flow diagram the shows a method for bandwidth usage improvement, as enabled by the code page and additional information transfer, disclosed herein. Ad that are to be transmitted from the ad store 201 are converted from a frame-by-frame format to a static code page plus additional information, as discussed above. This is performed in the code page generator 202. The code page generator 202 compares all frames in the ad for the purpose of extraction of the static content common to all frames of the ad. Because each frame of the ad contains a section which is invariant and common, and a section that changes, each frame can be considered as having a common picture that is a non-changing picture portion plus a changing video portion. The code generator extracts only the common information that does not vary across all frames. Hence, this code page is in the form of a picture with no video content. This forms the static code page for the ad. The static code page is compared to each frame and the additional information for regeneration of each frame is also extracted. The converted static code page and additional information are supplied to the mobile communication server 203 for encoding, and are then sent to an encoder/transmitter unit 204 that is part of the communication network. The transmitted data are received by the MHD. A decoder 205 in the MHD converts the received data into the static code page plus the additional information. This information is used in a frame-by-frame regenerator 206 to reproduce the frame-by-frame format of the original data of the static code page and additional information received at the MHD. This regenerated frame-by-frame ad is stored in the display-ready ad store 207 in the MHD for rendering and display at an appropriate ad spot. In another embodiment of the invention, the page code and the additional respective information are stored in the store 207 and prepared for display only upon a need to display the specific ad.

Because the static code page is a static entity it uses very little transmission bandwidth. Similarly, the additional information per frame is a much smaller data size than the original frame and, hence, needs only a smaller bandwidth for transmission. The use of the static code page and additional information enables the maximum use of the limited available bandwidth by reducing the frame-by-frame transmission of the ad, as would have been done using prior art solutions. The reduced bandwidth usage per ad allows the transmission of multiple ads simultaneously over the channel within the available bandwidth, and thus enhances the ability of the system to deliver ads to MHDs over a bandwidth-limited wireless link. This enables multiple ad delivery to multiple target groups simultaneously over available wireless spectrum, thereby enhancing the effectiveness and capability of the system for ad display.

Even though the generation and use of the code page and additional information for ad transfer over wireless link to the MHD units is described herein, it is not meant to be limiting. This invention can be used to reduce the need for high continuous bandwidth when using other transmission media which have limited or otherwise constrained bandwidth availability. Such applications will be apparent to individuals knowledgeable in the art and such uses and applications of the code page and additional information are covered by this application. The invention may be implemented in hardware, software, firmware or any combination thereof. In the form of software the invention will be in the form of tangible media readable by a computer and containing a plurality of instructions that when executed on an appropriate hardware results in the teachings made hereinabove.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for delivering advertisements over a limited-bandwidth wireless medium, comprising the steps of:
providing an advertisement for transmission to a mobile handheld display (MHD), said advertisement comprising a plurality of frames;
comparing all of said frames of said advertisement with each other to generate a static code page that is invariant through all of said frames;
extracting all elements of said static code page from each of said frames to generate additional information content for each of said frames;
transmitting said static code page to a plurality of MHDs; and
transmitting said additional information to said MHDs.

2. The method of claim 1, further comprising the step of:
combining said static code page with said additional information for each frame on at least one of said MHDs to regenerate said advertisement on said MHD.

3. The method in claim 1, further comprising the step of:
transmitting said static code page as a picture with no video content.

4. The method of claim 1, further comprising the steps of:
using temporal compression to reduce said additional information on a frame-by-frame basis.

5. A method for delivering an advertisement over a limited-bandwidth wireless medium, comprising the steps of:
providing an advertisement for transmission to a mobile handheld display (MHD), said advertisement comprising a plurality of frames;
comparing all frames of said advertisement with each other to generate a static code page that is invariant through all of said frames;
extracting all elements of said static code page from each of said frames to generate additional information content for each of said fames;
transmitting said static code page to at least one MHD as a picture; and
transmitting said additional information to said MHD;
combining said additional information with said static code page at said MHD to regenerate each of said frames.

6. The method of claim 5, further comprising the steps of:
using temporal compression to reduce said additional information on a frame-by-frame basis.

7. An apparatus for sending advertisements to a mobile handheld device (MHD), comprising:
an advertisement server;
an administration server;
a code page generator that is constructed to receive an advertisement from said advertisement server, to compare all frames of said advertisement clip with each other, and to extract a static code page and related information from said advertisement that, when received by a MHD, enable the reconstruction of said advertisement at said MHD; and
a transmitter for transmitting said static code page and said related information to said MHD.

8. The apparatus of claim 7, further comprising:
means for using temporal compression to reduce said additional information on a frame-by-frame basis.

9. A handheld device, comprising:
a receiver;
a processing unit;
a memory;
such that the handheld device is enabled to receive a static code page and related information from a transmitter that enables the generation of an advertisement, by generating each frame of said advertisement from said static code page and said related information, without having frame-to-frame differences either provided or generated.
